(19) United States
(12) Patent Application Publication
(10) Pub. No.: US 2026/0097641 A1
(43) Pub. Date: Apr. 9, 2026

(54) INTERFACE MEMBER FOR A COOLING SYSTEM

(71) Applicant: VOLVO PENTA CORPORATION, Göteborg (SE)

(72) Inventors: Andreas Broqvist, Göteborg (SE); Viktor Andersson, Göteborg (SE)

(73) Assignee: VOLVO PENTA CORPORATION, Göteborg (SE)

(21) Appl. No.: 19/349,388

(22) Filed: Oct. 3, 2025

(30) Foreign Application Priority Data
Oct. 8, 2024 (EP) 24205372.6

(51) Int. Cl. B60K 11/04

(52) U.S. Cl. CPC B60K 11/04

(57) ABSTRACT

An interface member for a cooling system is provided for cooling at least one thermally managed component intended to form a part of a powertrain system. The interface member has a support mounting interface configured to be mounted to a support structure for supporting the interface member, a body portion provided with one or more internal integrated coolant channels for forming at least a portion of a cooling circuitry of the cooling system, a coolant connection interface in fluid communication with the one or more integrated coolant channel and configured to be releasably connected to one or more cooling system components of the cooling system connected to the cooling circuitry for coolant distribution between the one or more cooling system components and the cooling circuitry, and a component mounting interface for mounting of one or more component associated with the powertrain system.

### TECHNICAL FIELD

The disclosure relates generally to cooling systems. In particular aspects, the disclosure relates to an interface member for a cooling system. The disclosure can be applied powertrain systems for example to powertrains of vehicles, e.g. heavy-duty vehicles, such as trucks, buses, and construction equipment, among other vehicle types. The disclosure may also be applied to for example marine vessel, power take off systems, industrial motor systems etc. Although the disclosure may be described with respect to a particular type of powertrain system, the disclosure is not restricted to any particular powertrain system.

### BACKGROUND

In modern powertrain systems, efficient thermal management is crucial to ensure optimal performance, reliability, and longevity of various components. These systems often include high-powered electronic devices, mechanical components, and other critical elements that generate substantial amounts of heat during operation. Consequently, effective cooling solutions are imperative to prevent overheating, component failure, and potential safety hazards.

Traditional cooling systems in powertrain applications typically involve multiple discrete components connected through a series of external piping or tubing. These systems often suffer from several significant drawbacks that hinder their overall efficiency and reliability.

One primary issue with existing cooling solutions is their complexity and the number of individual parts involved. The need for multiple connections and interfaces increases the risk of leaks, pressure drops, and malfunctions. The intricacy of assembling these systems also leads to higher installation costs and longer assembly times, which are undesirable in manufacturing processes that prioritize efficiency and cost-effectiveness.

Another notable disadvantage of conventional cooling systems is their lack of integration and modularity. The separate components and their connections make it challenging to achieve a compact and streamlined design. This can result in space constraints within the powertrain system, making it difficult to accommodate other necessary components or to maintain a desirable form factor.

Additionally, maintenance and servicing of these conventional cooling systems can be cumbersome and time-consuming. The multitude of connections and interfaces requires careful inspection and potential replacement of several parts during routine maintenance. This increases downtime and operational costs, further exacerbating the inefficiencies of these systems.

In summary, there is a clear need for an improved cooling solution that addresses the limitations of prior art systems.

### SUMMARY

According to a first aspect an interface member for a cooling system for cooling at least one thermally managed component intended to form a part of a powertrain system is provided. The interface member comprises a support mounting interface configured to be mounted to a support structure for supporting the interface member, a body portion provided with one or more internal integrated coolant channels for forming at least a portion of a cooling circuitry of the cooling system, a coolant connection interface in fluid communication with the one or more integrated coolant channels and configured to be releasably connected to one or more cooling system components of the cooling system connected to the cooling circuitry for coolant distribution between the one or more cooling system components and the cooling circuitry, and a component mounting interface for mounting of one or more components associated with the powertrain system. The first aspect of the disclosure may seek to address the complexity of traditional cooling systems by providing solution allowing for a modular system. A technical benefit may include simplifying the assembly and maintenance process over traditional systems that rely on multiple discrete components and external piping.

Optionally in some examples, including in at least one preferred example, the coolant connection interface may be configured to be releasably connected to two or more cooling system components of the cooling system such that coolant is distributed between the one or more cooling system components via at least one of the one or more integrated coolant channels. A technical benefit may include improved flexibility in connecting multiple cooling components, enhancing overall system adaptability.

Optionally in some examples, including in at least one preferred example, the component mounting interface may be configured to support at least one of the one or more cooling system components. A technical benefit may include providing a modular system enabling easy installation and service.

Optionally in some examples, including in at least one preferred example, the component mounting interface may be configured to support at least one thermally managed component configured to be cooled by means of the cooling system. A technical benefit may include providing a modular cooling system enabling easy installation and service.

Optionally in some examples, including in at least one preferred example, the component mounting interface may be configured to support at least one component associated with the operation of the powertrain system. A technical benefit may include enhancing the integration of various powertrain components, simplifying system design and maintenance.

Optionally in some examples, including in at least one preferred example, the one or more components associated with the powertrain system may comprise a control unit, a pump, a compressor, a power converter unit, an on board charger unit and/or an electrical power supply and/or a heat exchanger. A technical benefit may include providing mounting options for various components, enhancing modularity, assembling and service.

Optionally in some examples, including in at least one preferred example, the interface member may further comprise sensor circuitry mounted to the body portion and configured to monitor the operation of the cooling system. A technical benefit may include enabling real-time monitoring and diagnostics in a more non-complex and simple manner.

Optionally in some examples, including in at least one preferred example, the coolant connection interface may comprise a plurality of coolant connections configured to be releasably connected to the one or more cooling system components of the cooling system. A technical benefit may include facilitating interconnection of multiple cooling system components in a modular manner.

Optionally in some examples, including in at least one preferred example, the coolant connections may comprise sealing arrangements configured to provide a sealed connection between said coolant connection and the cooling system component. A technical benefit may include preventing leaks and maintaining system integrity.

Optionally in some examples, including in at least one preferred example, the plurality of coolant connections may be configured to form a part of a male-female fluid connection and/or a quick fluid connection. A technical benefit may include simplifying the connection process, reducing installation time and effort.

Optionally in some examples, including in at least one preferred example, each integrated coolant channel may be connected to a first and second coolant connection configured to be releasably connected to a cooling system component. A technical benefit may include providing a simple manner of interconnecting cooling system components.

Optionally in some examples, including in at least one preferred example, the body portion may be provided with a plurality of integrated coolant channels each being connected to a first and second coolant connection configured to be releasably connected to a cooling system component such that a plurality of cooling system components are selectively connectable to the coolant connection interface. A technical benefit may include allowing for flexible configuration and optimization of the cooling system layout.

Optionally in some examples, including in at least one preferred example, the body portion may be provided with at least one pump inlet connected to at least one coolant connection and configured to form an inlet of a pump to be mounted to the component mounting interface. A technical benefit may include integrating pump connections, simplifying system design and assembling as well as space consumption.

Optionally in some examples, including in at least one preferred example, wherein the body portion is provided with at least one pump outlet connected to the at least one coolant connection and configured to form an outlet of a pump. A technical benefit may include integrating pump connections, simplifying system design and assembling as well as space consumption.

Optionally in some examples, including in at least one preferred example, the component mounting interface may be configured to form a pump housing section configured to be connected to a mating housing section of the pump to together form the pump housing of said pump. A technical benefit may include providing an integrated housing for the pump, reducing assembly complexity and allowing for a more compact solution.

Optionally in some examples, including in at least one preferred example, the component mounting interface may comprise a pump housing mounting for mounting of the mating housing section. A technical benefit may include ensuring precise alignment and secure attachment of the pump housing, enhancing operational stability.

Optionally in some examples, including in at least one preferred example, the component mounting interface may be configured to accommodate mounting of one or more electrical components associated with the powertrain system connected to a power source of the powertrain system by means of electrical circuitry. A technical benefit may include facilitating the integration of electrical components, improving system functionality and ease of maintenance.

Optionally in some examples, including in at least one preferred example, the body portion may be provided with one or more electrical ground connections. A technical benefit may include ensuring proper grounding and electrical safety for the system in a space-efficient manner.

Optionally in some examples, including in at least one preferred example, the coolant connection interface may be configured to be releasably connected to two or more cooling system components of the cooling system such that coolant is distributed between the one or more cooling system components via at least one of the one or more integrated coolant channels, wherein a first cooling system component of the two or more cooling system components is a pump and a second cooling system component of the two or more cooling system components is a heat exchanger and wherein the component mounting interface is configured to form a pump housing section configured to be connected to a mating housing section of the pump to together form the pump housing of said pump. A technical benefit may include allowing for an easily installed and serviced cooling system. Another technical benefit may include allowing for a more space efficient cooling system.

According to a second aspect of the disclosure, a power train system is provided. The powertrain system comprises at least one thermally managed component and a cooling system, the cooling system comprising an interface member of any of the examples described herein. The second aspect of the disclosure may seek to address the complexity of traditional cooling systems of powertrain systems by providing solution allowing for a modular system. A technical benefit may include simplifying the assembly and maintenance process over traditional systems that rely on multiple discrete components and external piping.

Optionally in some examples, including in at least one preferred example, the at least one thermally managed component may comprise one or more of an electrical motor, an energy storage system, a transmission system, a power takeoff unit, a control unit, a compressor, a power converter unit, an on board charger unit and/or an electrical power supply. A technical benefit may include enabling cooling of a powertrain component in a simple and modular manner.

Optionally in some examples, including in at least one preferred example, the support mounting interface may be configured to be mounted to a chassis. A technical benefit may include ensuring secure attachment and stability of the interface member.

Optionally in some examples, including in at least one preferred example, the cooling system may be a liquid cooling system. A technical benefit may include providing efficient and effective thermal management through liquid cooling, improving overall system performance and longevity.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a block diagram of an exemplary powertrain system according to an example.

FIG. 2 is a block diagram of an exemplary powertrain system according to a more detailed example.

FIG. 3 is a block diagram of an interface member and connected components according to an example.

FIG. 4 is a perspective view of an interface member according to one example.

FIG. 5A is a cross-section view of the interface member of FIG. 4 according to one example.

FIG. 5B is another cross-section view of the interface member of FIG. 4 according to one example.

FIG. 6A is a perspective view of a pump of a cooling system according to an example.

FIG. 6B is a cross-section view of the pump of FIG. 6A according to an example.

FIG. 7A is a cross-section view of aspects of a coolant connection interface of the interface member according to an example.

FIG. 7B is another cross-section view of aspects of a coolant connection interface of the interface member according to another example.

FIG. 8 is a perspective view of a ground connection interface of the interface member according to an example.

### DETAILED DESCRIPTION

The detailed description set forth below provides information and examples of the disclosed technology with sufficient detail to enable those skilled in the art to practice the disclosure.

The present disclosure relates to cooling systems for cooling components of a powertrain system.

A powertrain system is a fundamental component of any vehicle or machinery that encompasses all the elements responsible for generating power and delivering it to the point of application, whether it be road surface, water, or industrial machinery. This system typically includes the engine or motor, transmission, drive shafts, differentials, and the final drive components such as wheels, propellers, or other output mechanisms. Essentially, the powertrain system converts the energy from the engine or motor into mechanical power that moves the vehicle or operates the machinery.

Examples of powertrain systems vary depending on the type of application and its propulsion technology. In traditional internal combustion engine (ICE) vehicles, the powertrain system includes the engine, gearbox, driveshaft, and differential. For electric vehicles (EVs), the powertrain system comprises the electric motor, battery pack, power electronics, and transmission. Hybrid vehicles combine elements from both ICE and EV powertrains, including an internal combustion engine, electric motor, battery, and transmission system.

In marine applications, powertrain systems are critical for the propulsion and maneuvering of vessels. These systems typically include marine engines, gearboxes, propeller shafts, and propellers. Marine powertrain systems must be robust and reliable to withstand the harsh operating conditions at sea and ensure the safe and efficient operation of the vessel.

In industrial applications, powertrain systems are used to drive machinery and equipment in various sectors, including manufacturing, construction, and agriculture. These systems may include engines or motors, transmissions, drive shafts, and final drive components such as wheels, tracks, or conveyor belts. Industrial powertrain systems are designed to deliver precise and efficient power to operate heavy machinery and equipment under demanding conditions.

Traditional cooling systems for powertrain systems typically involve multiple discrete components connected through a series of external piping or tubing, which suffer from several significant drawbacks. These include a complexity that increases the risk of leaks, pressure drops, and malfunctions, leading to higher installation costs and longer assembly times. Moreover, the lack of integration and modularity in these systems often results in space constraints within the powertrain system, making it challenging to accommodate other necessary components or to maintain a desirable form factor. Additionally, the cooling performance of traditional systems is often suboptimal due to inefficient heat transfer and distribution mechanisms. Maintenance and servicing of conventional cooling systems can also be cumbersome and time-consuming, as the multitude of connections and interfaces requires careful inspection and potential replacement of several parts during routine maintenance, increasing downtime and operational costs.

The present disclosure relates to an interface member intended for a cooling system for a powertrain system intended to address at least some of the above discussed challenges and drawbacks.

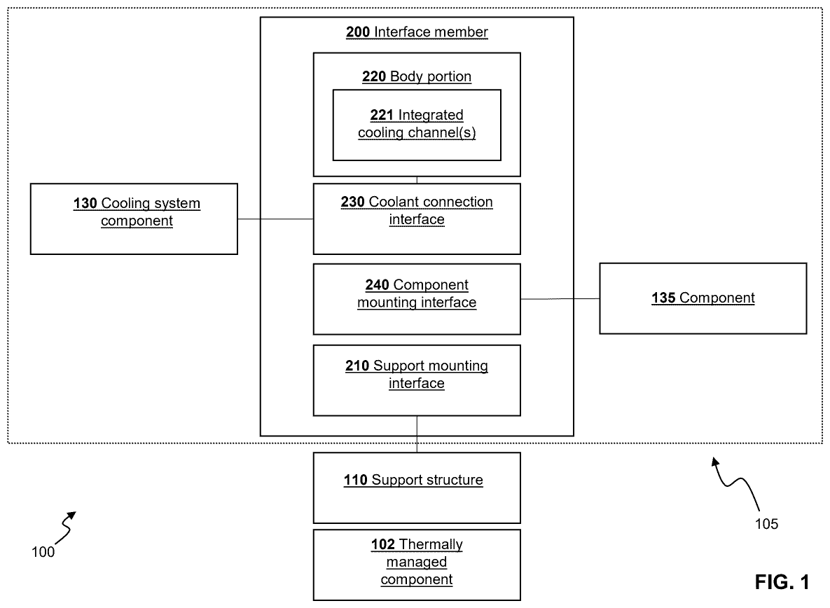

FIG. 1 shows a schematic block diagram of an exemplary powertrain system 100 with an interface member 200 according to one example.

An interface member 200 for a cooling system 105 for cooling least one thermally managed component 102 is provided. The thermally managed component 102 is intended to form a part of a powertrain system 100. The interface member 200 includes several integral features which will be described in further detail.

The interface member 200 comprises a support mounting interface 210, a body portion 220 provided with internal integrated coolant channels 221, a coolant connection interface 230, and a component mounting interface 240.

The support mounting interface 210 is configured to be mounted to a support structure 110. The body portion 220 is provided with one or more internal integrated coolant channels 221 for forming at least a portion of the cooling circuitry of the cooling system 105. The coolant connection interface 230 is in fluid communication with the one or more integrated coolant channels 221. The coolant connection interface 230 is configured to be releasably connected to one or more cooling system components 130 of the cooling system 105. The one or more cooling system components 130 are connected to the cooling circuitry for coolant distribution between the one or more cooling system components 130 and the cooling circuitry. The component mounting interface 240 is provided for mounting of one or more component 135 associated with the powertrain system 100.

By integrating these elements into a single, cohesive unit, the interface member may simplify the overall design and installation process. This reduces the complexity and number of individual parts involved, thereby minimizing the risk of leaks and malfunctions. The integrated design may also enhance the system's modularity, allowing for a more compact and streamlined arrangement that can accommodate other necessary components within the powertrain system more easily. The ease of assembly and disassembly provided by the releasable connections simplifies maintenance procedures, reducing downtime and operational costs.

The interface member may offer several technical benefits over prior art solutions. Firstly, it may enhance cooling efficiency and simplifies the assembly and maintenance process, addressing the primary issues of complexity and inefficiency in traditional systems. Secondly, it may provide improved flexibility in connecting multiple cooling system components, enhancing overall system adaptability. Thirdly, it may improve thermal management for critical components, improving performance and longevity. Fourthly, it may facilitate the integration of various powertrain components, simplifying system design and maintenance. Fifthly, it may provide versatile mounting options for various critical components, enhancing overall system functionality.

A thermally managed component 102 may herein refer to a component to be receiving cooling from the cooling system 100, e.g. a component cooled by means of the cooling system 105. The cooling circuitry of the cooling system 100 may thus be routed to the thermally managed component 102. As will be described in further detail, the thermally managed component 102 may any type of component intended to form a part of the powertrain system 100.

The term powertrain system 100 is herein broadly applied to any type of system intended to drive an output component. Accordingly, the powertrain system 100 may be a vehicle powertrain system for propelling a vehicle. The vehicle may for example be a heavy-duty vehicle, such as truck, bus, or construction equipment, among other vehicle types. The powertrain system 100 may be a marine powertrain system for propelling a marine vessel. The powertrain system 100 may be an industrial powertrain system for industrial applications, e.g. for driving an output mechanism, the output mechanism may be a power plant, a power take off unit etc. The thermally managed component 102 may thus be any component intended to form a part of such a powertrain system 100.

Depending on the type of powertrain system 100, the one or more thermally managed component 102 may differ. For example, it may be envisioned that the one or more thermally managed component 102 may comprise at least one of a control unit, a compressor, a power converter unit, an on board charger unit, an electrical power supply, an engine, an electrical motor, an energy storage system such as a battery system, a transmission system and a power take off unit.

As aforementioned, the support mounting interface 210 provided may be configured to be mounted to a support structure 110 for supporting the interface member 200. The support structure 110 may be form a part of the powertrain system 100 but may preferably be arranged independently from the powertrain system 100 to improve easy of assembly, service and installation. For example, the support structure 110 may be in the form of a chassis, for example a chassis of a vehicle, marine vessel or industrial machine.

Cooling circuitry may herein refer to fluid distribution circuitry intended to distribute the coolant between the components of the cooling system 105, e.g. the cooling system components 130. The cooling circuitry may thus comprise one or more fluid lines configured to connect the components of the cooling system 105, e.g. the cooling system components 130, to enable fluid communication. The cooling circuitry may comprise (in addition to the internal integrated coolant channels 221 any type of conventional fluid connections such as hosing, piping or tubing. It may also be envisioned that the one or more integrated internal coolant channels 221 comprise the entirety of the cooling circuitry of the cooling system 105, i.e. that the one or more integrated internal coolant channels 221 directly connects to the one or more cooling system components 130 without any intermediate fluid connection means in-between.

Cooling system component 130 may herein refer to any component forming a part of the cooling system 105, e.g. a component in fluid communication with the cooling circuitry. Hence, the cooling system component 130 may herein refer to any component intended to receive and/or discharge coolant from and/or to the cooling circuitry.

Worded differently, a cooling system component 130 may herein refer to any device or element that forms part of the cooling system 105. The cooling system component 130 may be configured to contribute to the regulation, distribution, or dissipation of heat within the one or more thermally managed component 102. Accordingly, the one or more cooling system components 130 may be for ensuring that the one or more thermally managed components 102 operate within desirable temperature ranges.

As the skilled person is aware a large variety of such components may be envisioned. For example, the at least one cooling system component 130 may for example comprise a pump such as a coolant pump or a heat exchanger such as a radiator, oil cooler or intercooler.

Advantageously, the cooling system 100 may be a liquid cooling system. The coolant may accordingly be for example water-, oil- or glycol-based or any mixtures thereof.

The component mounting interface 240 may be configured to accommodate for mounting of one or more component 135 associated with the powertrain system 100. The component mounting interface 240 may be configured to accommodate for mounting of said component 135 to the body portion 220.

A component 135 associated with the powertrain system 100 may herein refer to any type of functional component of the powertrain system 100. For example, the component 135 may be a cooling system component 130 or may be a component intended to be cooled by means of the cooling system 105 such as at least one of the one or more thermally managed components 102 or a component not forming a part of the cooling system 105 or being cooled by the cooling system and providing other functionality to the powertrain system 100. Accordingly, the component 135 may comprise any one of a cooling system component 130, a thermally managed component 102 or a component not forming a part of the cooling system 105 or cooled by the cooling system 105. Hence, the component mounting interface 240 may be for mounting of one or more of at least one additional cooling system component 130, at least one additional thermally managed component 102, at least one component not being cooled by the cool system 105 and at least one component not forming a part of the cooling system 105. The component 135 may thus be considered any type of component associated with the operation of the powertrain system 100 which may include thermally managed components, cooling system components and other functional components of the powertrain system 100.

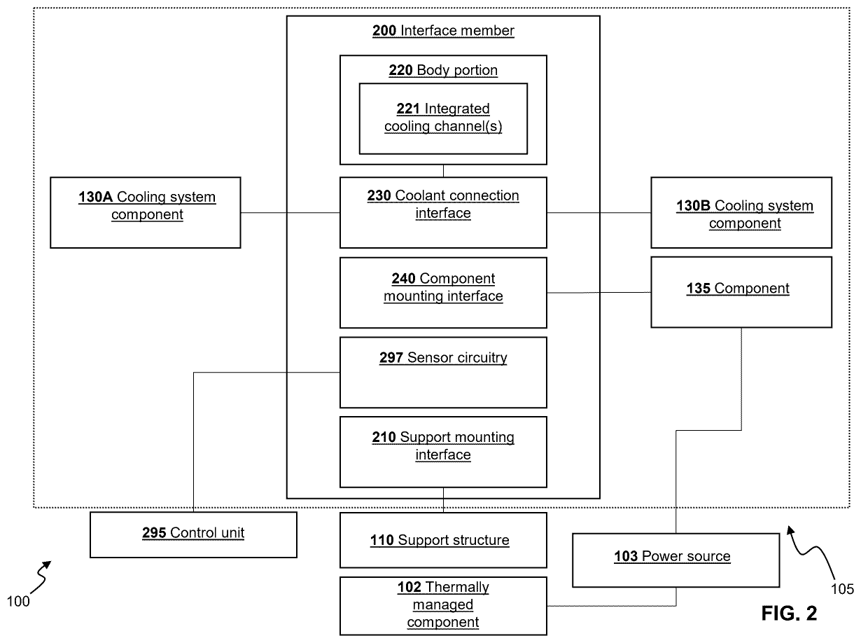

FIG. 2 shows a schematic block diagram of an exemplary powertrain system 100 with an interface member 200 according to a more detailed example.

As depicted in FIG. 2, the coolant connection interface 230 may be configured to be releasably connected to two or more cooling system components 130 of the cooling system 105. Accordingly, a first cooling system component 130A and a second cooling system component 130B may be provided. The coolant connection interface 230 may be configured to be releasably connected to the two or more cooling system components, e.g. the first and second cooling system component 130A-B, such that coolant can be distributed between the one or more cooling system components 130, e.g. the first and second cooling system component 130A-B. The coolant may be distributed via at least one of the one or more integrated coolant channels 221.

Further referencing FIG. 2, the component mounting interface 240 is as previously explained configured to accommodate for mounting of one or more components 135 associated with the powertrains system 100.

In one example, the component mounting interface 240 may be configured to support at least one of the one or more cooling system components 130.

In one example, the component mounting interface 240 may be configured to support at least one thermally managed component 102, e.g. at least one thermally managed component 102 configured to be cooled by means of the cooling system 105.

In one example, the component mounting interface 240 may be configured to support at least one component associated with the operation of the powertrain system 100.

In one example, the component mounting interface 240 may be configured to accommodate mounting of one or more electrical components. The electrical components may be associated with the powertrain system 100. The electrical components may be connected to, e.g. electrically connected to, a power source 103 of the powertrain system 100. The one or more electrical components may be connected to the power source 103 by means of electrical circuitry 290. The power source 103 may be any type of conventional power source such as a fuel cell system or a battery system.

For example, the one or more component 135 associated with the powertrain system 100 may comprise a control unit, a pump, a compressor, a power converter unit, an on board charger unit, an electrical power supply and/or a heat exchanger.

Further referencing FIG. 2, the interface member 290 may comprise sensor circuitry 297. The sensor circuitry 297 may be configured to monitor the operation of the cooling system 105. The sensor circuitry 297 may comprise one or more sensors configured to monitor said operation of the cooling system 105. To exemplify, the sensor circuitry 297 may comprise one or more temperature sensors configured to monitor the temperature of the coolant and/or one or more flow sensors configured to monitor the flow of the coolant. The sensor circuitry 297 may comprise one or more sensors arranged in the internal integrated coolant channel(s) 221 for monitoring parameters relating the coolant flowing through said internal integrated coolant channel(s).

In one example, a control unit 295 may be provided. The control unit 295 may be configured to control the cooling system 105. In one example, the control unit 295 may be configured to control at least one of the one or more cooling system components 130. It may be envisioned that the control unit 295 may be considered a component associated with the operation of the powertrains system 100 as described above.

In one example, the component mounting interface 240 may be configured to receive and support the control unit 295. The component mounting interface 240 may be configured to accommodate for mounting of the control unit 295 to the interface member 200, e.g. the body portion 220.

In one example, the sensor circuitry 297 may be configured to be in operative connection with the control unit 295. The control unit 295 may be configured to control the cooling system 105 based on sensor data obtained from the sensor circuitry 297.

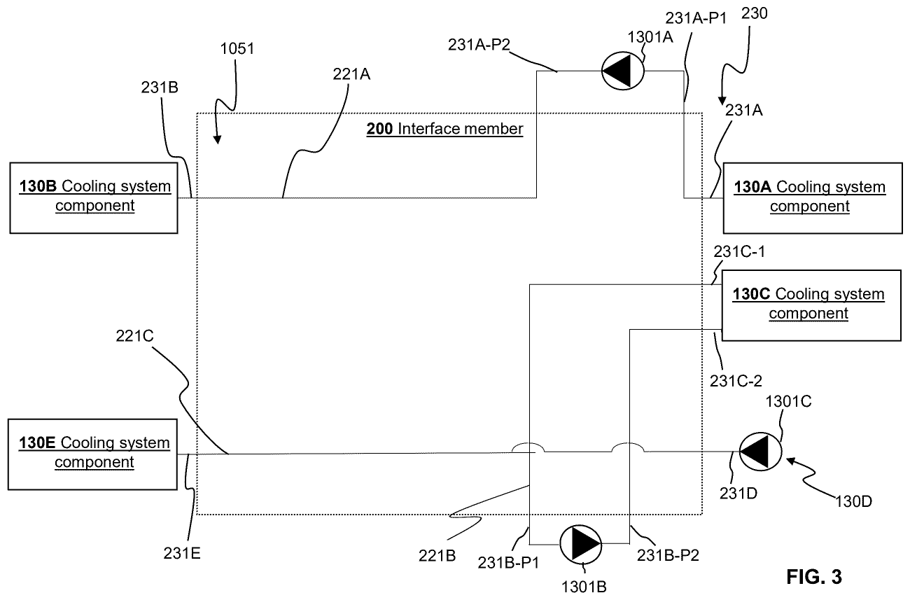

FIG. 3 schematically depicts an example of the cooling system 105 in further detail.

For exemplifying purposes, FIG. 3 depicts a plurality of cooling system components 130 being connected to, e.g. in fluid communication with, the one or more internal integrated coolant channels 221.

In the depicted example, the cooling system 105 comprises cooling circuitry 1051. The one or more internal integrated coolant channels 221 may be configured to form a part of the cooling circuitry 1051.

The coolant connection interface 230 may comprise a plurality of coolant connections 231. The plurality of coolant connections may be configured to be releasably connected to the one or more cooling system components 130 of the cooling system 105. The plurality of coolant connections 231 may be configured to establish releasable fluid communication with the one or more cooling system components 130.

Referencing FIG. 3, each integrated coolant channel 221 may be connected to, e.g. in fluid communication with, a first and second coolant connection 231. The first and second coolant connection 231 may configured to be releasably connected to a cooling system component 130.

Advantageously, the body portion 220 may be provided with a plurality of integrated coolant channels 221. Each integrated coolant channel 221 may be connected to a first and second coolant connection 231 configured to be releasably connected to a cooling system component 130 such that a plurality of cooling system components 130 may be selectively connectable to the coolant connection interface 230.

In the example depicted in FIG. 3, a plurality of integrated coolant channels 221 are provided. The plurality of integrated coolant channels 221 may be arranged as parallel integrated coolant channels, e.g. the integrated coolant channels 221 may not be in fluid communication with each other.

Please note that the numbering of the components discussed with reference to FIG. 3 is only exemplary, it may be envisioned that any of the of components may be omitted and/or introduced in any order, e.g. as first, second, third etc.

One of the integrated coolant channels 221, e.g. a first integrated coolant channel 221A may be configured to fluidly interconnect, e.g. accommodate for fluid communication between, a first cooling system component 130A and a second cooling system component 130B.

The first integrated coolant channel 221A may be configured to be connected to a first associated coolant connection 231A and a second associated coolant connection 231B. The first coolant connection 231A may be configured to be releasably connected to a first cooling system component 130A and the second coolant connection 231B may be configured to be releasably connected to a second cooling system component 130B. The first integrated coolant channel 221A may thus accommodate for fluid communication between the first cooling system component 130A and the second cooling system component 130B.

In the depicted example, the first integrated coolant channel 221 may be configured to be connected to a pump 1301A of the cooling system 105, e.g. a pump 1301A connected to the cooling circuitry 1051. The pump 1301A may be arranged between the first cooling system component 130A and the second cooling system component 130B. The pump 1301 may be configured to control the flow of coolant between the first cooling system component 130A and the second cooling system component 130B. Notably, the pump 1301A may be considered a cooling system component 130, e.g. a third cooling system component 130 intended to be connected to the first integrated coolant channel 221.

In one example, the coolant connection interface 230 may be configured to be releasably connected to said pump 1301A. Accordingly, one or more coolant connections 231 may be configured to be connected to the pump 1301A. In the depicted example, the first integrated coolant channel 221A may be connected to a third coolant connection 231A-P1, the third coolant connection may be configured to be releasably connected to an inlet of the pump 1301A. In the depicted example, the first integrated coolant channel 221A may be connected to a fourth coolant connection 231A-P2, the fourth coolant connection 231A-P2 may be configured to be releasably connected to an outlet of the pump 1301A.

One of the integrated coolant channels 221, e.g. a second integrated coolant channel 221B may be configured to be in fluid connection with, e.g. in fluid communication with, a single cooling system component, e.g. a third cooling system component 130C.

The second integrated coolant channel 221B may be configured to be connected to a first associated coolant connection 231C-1 and a second associated coolant connection 231C-2. The first coolant connection 231C-1 may be configured to be releasably connected to a cooling system component, e.g. a third cooling system component 130C and the second coolant connection 231C-2 may be configured to also be releasably connected to said cooling system component, e.g. the third cooling system component 130C. Preferably, the first coolant connection interface 231C-1 may be configured to be releasably connected to an inlet of the cooling system component 130C. Preferably, the second coolant connection interface 231C-2 may be configured to be releasably connected to an outlet of the cooling system component 130C. The first integrated coolant channel 221A may thus accommodate for fluid communication between an inlet and an outlet of the cooling system component 130C.

In the depicted example, the second integrated coolant channel 221B may be configured to be connected to a pump 1301B of the cooling system 105, e.g. a pump 1301B connected to the cooling circuitry 1051. The pump 1301B may be arranged between the inlet and the outlet of the cooling system component 130C. The pump 1301B may be configured to control the flow of coolant between the inlet and the outlet of the cooling system component 130C. Notably, the pump 1301C may be considered a cooling system component 130 intended to be connected to the second integrated coolant channel 221B.

In one example, the coolant connection interface 230 may be configured to be releasably connected to said pump 1301B. Accordingly, one or more coolant connections 231 may be configured to be connected to the pump 1301B. In the depicted example, the second integrated coolant channel 221B may be connected to a third coolant connection 231B-P1, the third coolant connection may be configured to be releasably connected to an inlet of the pump 1301B. In the depicted example, the second integrated coolant channel 221B may be connected to a fourth coolant connection 231B-P2. The fourth coolant connection 231B-P2 may be configured to be releasably connected to an outlet of the pump 1301B.

One of the integrated coolant channels 221, e.g. a third integrated coolant channel 221C may be configured to fluidly interconnect, e.g. accommodate for fluid communication between, a fourth cooling system component 130D and a fifth cooling system component 130E.

The third integrated coolant channel 221C may be configured to be connected to a first associated coolant connection 231D and a second associated coolant connection 231E. The first coolant connection 231D may be configured to be releasably connected to a fourth cooling system component 130D and the second coolant connection 231E may be configured to be releasably connected to a fifth cooling system component 130E. The third integrated coolant channel 221E may thus accommodate for fluid communication between the fourth cooling system component 130D and the fifth cooling system component 130E.

In the depicted example, the fourth cooling system component 130D may be provided as a pump 1301C, e.g. a pump 1301A connected to the cooling circuitry 1051. The pump 1301C may be configured to control a flow of coolant to the fifth cooling system component 130E.

As the skilled person recognizes, the cooling circuitry 1051 may extend and may be routed to cool the one or more thermally managed components 102.

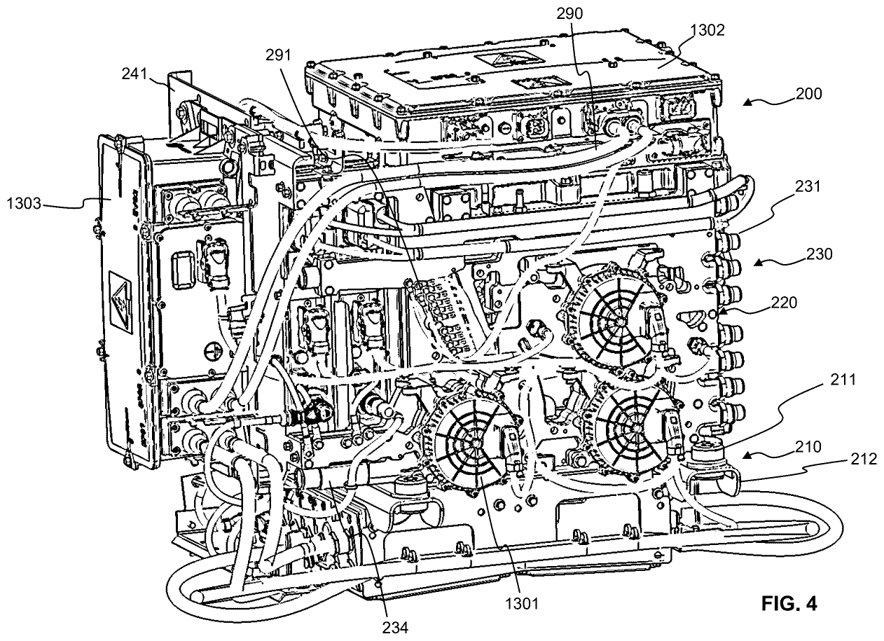

FIG. 4 depicts an interface member 200 according to an example.

The interface member 200 may form a unit for mounting to a support structure. The interface member 200 may be configured to form a node in a powertrain system 100, e.g. for a cooling system 105 of a powertrain system 100. The interface member 200 may thus be configured to be in releasable fluid connection with one or more cooling system components.

In one example, the interface member 200 may be molded, e.g. formed by means of molding. According to such an example, the one or more internal integrated coolant channels 221 may be integrally formed in the molding process. This may for example be achieved by means of inserts in the die.

In one example, the interface member 200 may be formed by a plurality of joined parts, whereby the one or more internal integrated coolant channels 221 may be formed by machined portions in one or more of said parts.

As aforementioned, the interface member 200 may comprise a support mounting interface 210 configured to be mounted to the support structure 110 for supporting the interface member 200. In one example, the support mounting interface 210 may be configured to rest on top of the support structure 110 upon mounting to enable easy assembling.

The component mounting interface 240 may comprise one or more brackets 241. The one or more brackets 241 may be mounted to the body portion 220. The one or more brackets 241 may be configured to provide a mounting surface for the one or components 135 associated with the powertrain system 100. The one or more brackets 241 may be configured to receive one or more fastening elements for mounting of the component to said bracket(s) 241.

In the depicted example, the support mounting interface 210 may comprise one or more flanged portions 212 adapted to abut to the support structure 110 and be fixated relative to the support structure 110 by means of one or more fastening elements 211. The one or more flanged portions 212 may be formed as protruding flanges, e.g. horizontal protruding flanges, of the body portion 220. The one or more fastening elements 211 may be provided in the form of screws or bolts. In one example, the one or more flanged portions 212 may be provided with holes for receiving said one or more fastening elements 211. It may however be envisioned that other types of fastening elements may be utilized such as clamping elements etc.

In the depicted example, one or more electrical components 1302, 1303 are provided. The one or more electrical components 1302, 1303 may be mounted to the interface member 200. Hence, the component mounting interface 240 may be configured to accommodate mounting of the one or more electrical components 1302, 1303. The one or more electrical components 1302, 1303 may be connected to the previously described power source 103. The one or more electrical components 1302, 1303 may be electrically connected to the power source 103 by means of electrical circuitry 290.

In the depicted example, a first electrical component 1302 and a second electrical component 1303. The component mounting interface 240 may be configured to enable mounting of said first electrical component 1302 and second electrical component 1303. As depicted, the first electrical component 1302 and the second electrical component 1303 may be electrically connected by means of electrical circuitry. In the depicted example, the first electrical component 1302 and the second electrical component 1303 may be electrically connected by means of quick connect electrical wiring. Further, the first and/or second electrical component may be connected to the power source 1303 by means of quick connect electrical wiring.

Although a plurality of electrical components may be envisioned, FIG. 4 depicts a first electrical component 1302 provided as an onboard charger unit and/or an electrical power supply, preferably a combined onboard charger unit and electrical power supply, and a second electrical component 1303 provided as a power converter unit. The onboard charger unit 1303 may be configured to be electrically connected to the power source 103 and may be configured to provide DC-charging to the power source 103. The combined onboard charger unit and electrical power supply 1302 may be electrically connected to the power converter unit 1303 for charging the power source 103. The combined onboard charger unit and electrical power supply 1302 may be configured to be electrically connected to an external power supply for charging the power source 103. In the depicted example, the combined onboard charger unit and electrical power supply 1302 may be bi-directional, e.g. it may be configured to transfer power to the power source 103 for charging of the power source 103 and transfer power from the power source 103 to power components of the powertrain system 100.

In the depicted example, the component mounting interface 240 may be configured to accommodate for mounting of at least one pump 1301. According to the depicted example, the at least one pump 1301 may be electrically connected to the combined onboard charger unit and electrical power supply 1302 for powering of said at least one pump 1301. The electrical circuitry 290 may thus be configured to electrically connect the onboard charger unit and electrical power supply 1302 and the at least one pump 1301.

The coolant connection interface 230 may comprise a plurality of coolant connections 231, 234. The coolant connections 231, 234 may be configured to be releasably connected to the one or more cooling system components 130 of the cooling system 105.

Depending on the intended application of the coolant connection interface 230 and consequently the plurality of coolant connections 231, 234 may be arranged in a plurality of ways to accommodate for simple assembling of the cooling system and space efficiency. It may for example be envisioned that the coolant connection interface 230 may comprise one or more groups of coolant connections 231, 234 distributed at different positions relative the body portion 220. Each group may comprise one coolant connection or a plurality of coolant connections grouped together.

In the depicted example, the coolant connection interface 230 may comprise a first coolant connection interface portion. The first coolant connection interface portion may comprise a plurality of coolant connections 231. The plurality of coolant connections 231 may be distributed side-by-side relative each other to enable easy connection with the one or more cooling system components 130.

It may further be envisioned that certain types of cooling system components 130 may due to space constraints or the overall design of the powertrain system 100 preferably be intended to be connected to the coolant connection interface 230 at a separate location. The coolant connection interface 230 may accordingly for example comprise a second coolant connection interface portion. In the depicted example, the second coolant connection interface portion comprises at least one coolant connection 234. In the depicted example, the at least one coolant connection 234 may be configured to be releasably connected to a heat exchanger of the cooling system 105 such as a radiator.

It may for example be envisioned that the first coolant connection interface part and the second coolant connection interface part are arranged at opposite sides of the body portion 220. In the depicted example, the first and second coolant connection interface part may be arranged at opposite vertical sides of the body portion 220.

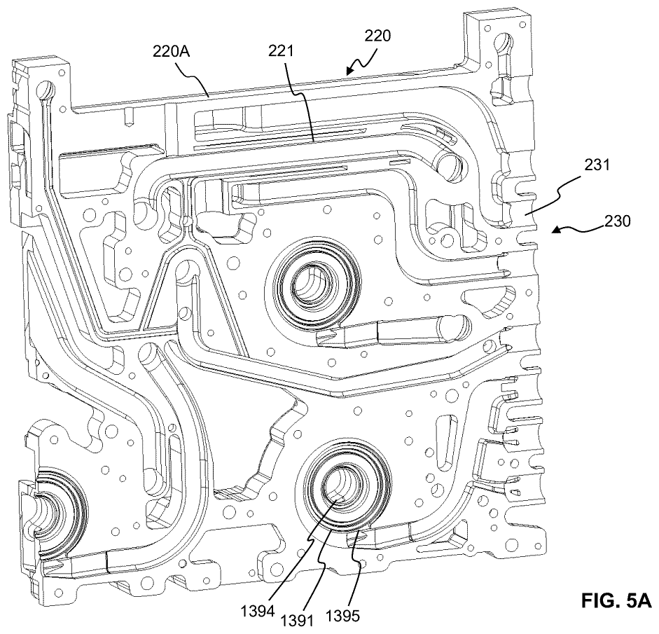

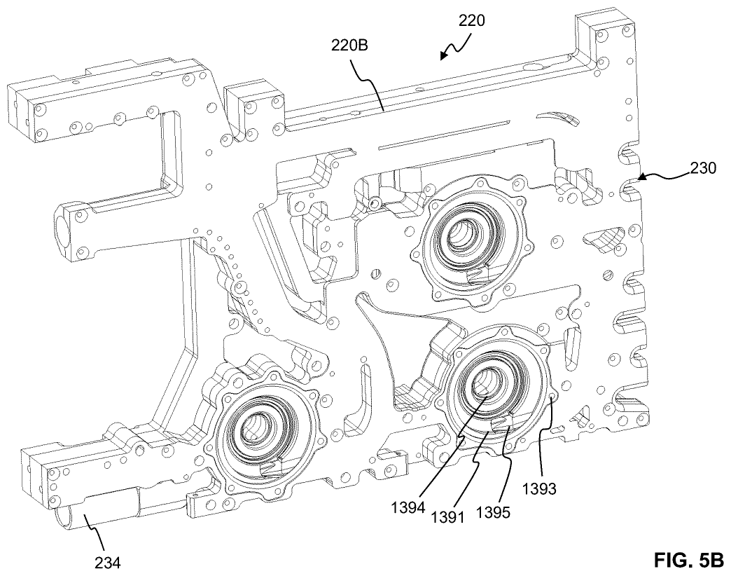

FIG. 5A-B depicts cross-sections of the body portion 220 depicted in FIG. 4. In the depicted example, the cross-sections corresponds to parts mounted together to form the body portion 220 and the one or more internal integrated coolant channel 221, but it may be envisioned that the cross-section views are schematic cross-section views of a molded body portion 221.

The component mounting interface 240 may be configured to accommodate for mounting of at least one pump 1301. In the depicted example, three pumps 1301 are mounted to the component mounting interface 240.

The body portion 220 may be provided with at least one pump inlet 1394 and/or pump outlet 1395. The pump inlet 1394 and the pump outlet 1395 may be considered to form a part of the coolant connection interface 230 and the pump 1301 may be considered a cooling system component 135 as described herein. Accordingly, the pump inlet 1394 and/or the pump outlet 1395 may be considered a coolant connection 231 as described herein.

In one example, the at least one pump 1301 may be a displacement pump. In one example, the pump inlet 1394 may extend in a direction substantially parallel with the rotation axis of the impeller of the pump 1301. In one example, the pump outlet 1395 may extend in a direction substantially tangential to the impeller.

The at least one pump inlet 1394 may be connected to, e.g. in fluid communication with, at least one coolant connection 231. The pump inlet 1394 may be configured to form an inlet of the pump 1301 to be mounted to the component mounting interface 240.

The at least one pump outlet 1395 may be connected to, e.g. in fluid communication with, at least one coolant connection. The pump outlet 1395 may be configured to form an outlet of the pump 1301 to be mounted to the component mounting interface 240.

The at least one pump 1301 may be arranged and connected to the one or more internal integrated cooling channels 221 according to any of the examples described with reference to FIG. 3 herein.

To allow for a more compact cooling system 105, the one or more pumps 1301 may be at least partially integrated in the interface member 200. The housing of the pump 1301, e.g. the pump housing of at least one of the one or more pumps 1301 may be at least partially integrated in the interface member 200.

To achieve the at least partial integration, the component mounting interface 240 may be configured to form a pump housing section 1391. The pump housing section 1391 may be configured to be connected to a mating housing section of the pump 1301 to together form the pump housing of the pump 1301.

In one example, the pump housing section 1391 may be provided as a recessed portion provided in the body portion 220. In the depicted example, the pump inlet 1394 is formed as an aperture in the recessed portion. Additionally or alternatively, the pump inlet 1394 may be formed as an aperture in the recessed portion.

As visible in FIG. 5B, the component mounting interface 240 may comprise a pump housing mounting 1393 for mounting of the mating housing section 1392. The pump housing mounting 1393 may be provided as a mounting flange. The mounting flange may form an annular rim enveloping the pump housing section 1391. Advantageously, the pump housing mounting 1393 may comprise one or more holes configured to receive fastening elements such as screws or bolts for mounting of the mating housing section.

In one example, the coolant connection interface 230 may be configured to be releasably connected to two or more cooling system components 130 of the cooling system 105 such that coolant may be distributed between the one or more cooling system components 130 via at least one of the one or more internal integrated coolant channels 221. A first cooling system component 130 may be the pump 1301 and the second cooling system component 130 may be a heat exchanger.

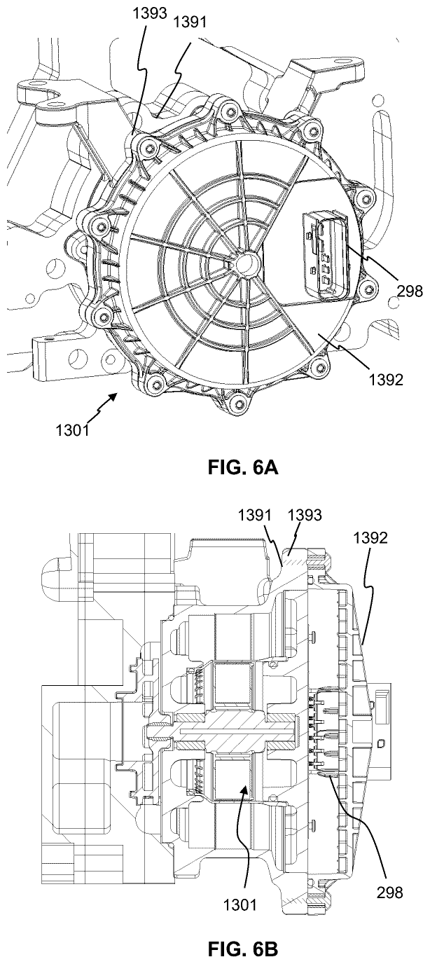

FIG. 6A-B depicts the pump 1301 when mounted to the interface member 200 in a perspective view and in a cross-section view.

Referencing said figures, the mating pump housing section 1392 may be configured to form a cover for sealing of the pump housing, e.g. for covering the pump housing section 1391. In the depicted example, the pump inlet 1394 as well as the pump outlet 1395 may be provided as apertures in the pump housing sections 1391. Accordingly, the mating housing section 1392 may be provided in the form of a cover for sealing off the recessed portion provided in the body portion 220 forming the pump housing section 1391.

Further referencing FIG. 6A-B, the pump 1301, e.g. the mating housing section 1392, may comprise a connector portion 298. The connector portion 298 may be configured to be connected to the electric circuitry 290 for power transfer and/or data transfer to the pump 1301.

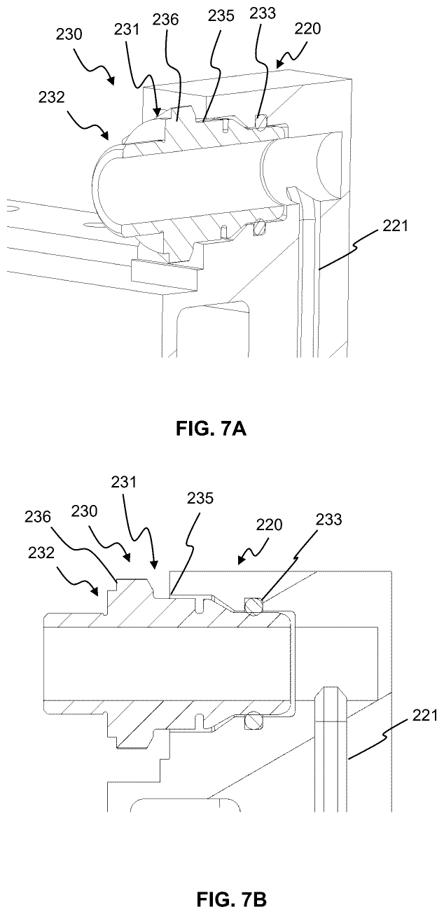

FIG. 7A-B depicts an exemplary coolant connection 231 of the interface member 200 in a side and perspective cross-section view.

The plurality of coolant connections 231 may be configured to form a part of a male-female fluid connection and/or a quick fluid connection. Hence, together with a mating connection, the coolant connections 231 may be configured to form such a male-female fluid connection and/or a quick fluid connection.

A quick fluid connection may be a coupling mechanism designed to facilitate rapid and secure attachment or detachment of fluid lines without the need for specialized tools. These connections typically feature a push-and-click or twist-lock mechanism, enabling efficient assembly and disassembly while maintaining a reliable and leak-proof seal.

A male-female fluid connection may involve a coupling system where one component, the male connector, fits snugly into another component, the female connector. This type of connection ensures a secure and leak-proof seal, allowing for efficient fluid transfer. The male connector typically has an external fitting that inserts into the corresponding internal fitting of the female connector.

It may however be envisioned that other releasable fluid connection means may be utilized. For example, the plurality of coolant connections 231, i.e. one or more of the plurality of coolant connections 231, may be configured to form a part of sleeve connection. According to such an example, the plurality of coolant connections 231 may form inserts to be positioned inside for example hose, tube or pipe to form a fluid connection.

In one example, hosing, tubing or piping may be avoided. Instead, the plurality of coolant connections 231, i.e. one or more of the plurality of coolant connections 231, may be configured to form docking fluid connections. Thus, at least one of the plurality of coolant connections 231 may be configured to releasably receive a cooling system component 130 such that fluid communication is established between the coolant connection 231 and the cooling system component 130. For example, this may be achieved by insertion of the coolant connection 231 in a fluid port of the cooling system component 130 or vice versa.

The plurality of coolant connections 231 may comprise sealing arrangements 232. The sealing arrangements may be configured to provide a sealed connection between the coolant connection 231 and the cooling system component 130. Worded differently, the sealing arrangement 232 may be configured to seal around the established fluid communication upon the coolant connection 231 being connected with a cooling system component 130. In one example, each coolant connection 231 may comprise a sealing arrangement 232.

The coolant connection 231 may comprise a coolant connector portion 235 for establishing fluid communication with the cooling system component 135. The coolant connector portion 235 may be mounted in the body portion 220. In one example, the sealing arrangement may comprise a sealing collar 236, the sealing collar 236 may be provided on the connector portion 235 or on the body portion. The sealing collar 236 may be configured to seal against an outer surface of the body portion 220 extending substantially perpendicular to the connector portion 235. The sealing collar 236 may be provided on the connector portion 235. The sealing collar 236 may be in the form of a radially protruding flange on the connector portion 235.

In one example, the sealing arrangement 232 may comprise a gasket 233 arranged between the connector portion 235 and the body portion 220 to seal between said connector portion 235 and the body portion 220.

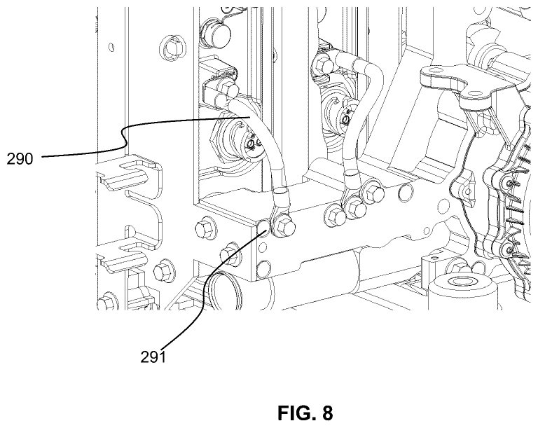

FIG. 8 depicts a portion of the interface member 200 according to one example. In particular, FIG. 8 depicts a part of the electric circuitry 290.

In order to save space and provide additional functionality, the body portion 220 may be provided with one or more electrical ground connection 291. The one or more ground connection 291 may be configured to be connected to the electrical circuitry 290. The one or more ground connection 291 may be configured to electrically connect the electrical circuitry 290 to the ground. The one or more ground connection may be configured to provide a ground connection for example for an electrical component intended to be mounted to the interface member 200 by means of the component mounting interface 240.

According to an aspect, an interface member, powertrain system, marine vessel, vehicle and/or stationary drive system according to any of the below examples may be provided.

Example 1: Interface member (200) for a cooling system (105) for cooling at least one thermally managed component (102) intended to form a part of a powertrain system (100), the interface member (200) comprising: a support mounting interface (210) configured to be mounted to a support structure (110) for supporting the interface member (200), a body portion (220) provided with one or more internal integrated coolant channels (221) for forming at least a portion of a cooling circuitry of the cooling system (105), a coolant connection interface (230) in fluid communication with the one or more integrated coolant channels (221) and configured to be releasably connected to one or more cooling system components (130) of the cooling system (105) connected to the cooling circuitry for coolant distribution between the one or more cooling system components (130) and the cooling circuitry, and a component mounting interface (240) for mounting of one or more components (135) associated with the powertrain system (100).

Example 2: The interface member (200) of Example 1, wherein the coolant connection interface (230) is configured to be releasably connected to two or more cooling system components (130) of the cooling system (105) such that coolant is distributed between the one or more cooling system components (130) via at least one of the one or more integrated coolant channels (221).

Example 3: The interface member (200) of Example 1 or Example 2, wherein the component mounting interface (240) is configured to support at least one of the one or more cooling system components (130).

Example 4: The interface member (200) of any of Example 1-Example 3, wherein the component mounting interface (240) is configured to support at least one thermally managed component (102) configured to be cooled by means of the cooling system (105).

Example 5: The interface member (200) of any of Example 1-Example 4, wherein the component mounting interface (240) is configured to support at least one component associated with the operation of the powertrain system (100).

Example 6: The interface member (200) of any of Example 1-Example 5, wherein the one or more components (135) associated with the powertrain system (100) comprises a control unit, a pump (1301), a compressor, a power converter unit (1303), an on-board charger unit and/or an electrical power supply (1302) and/or a heat exchanger.

Example 7: The interface member (200) of any of Example 1-Example 6, further comprising sensor circuitry (297) mounted to the body portion (220) and configured to monitor the operation of the cooling system (105).

Example 8: The interface member (200) of any of Example 1-Example 7, wherein the coolant connection interface (230) comprises a plurality of coolant connections (231, 234) configured to be releasably connected to the one or more cooling system components (130) of the cooling system.

Example 9: The interface member of Example 8, wherein the coolant connections (231, 234) comprise sealing arrangements (232) configured to provide a sealed connection between said coolant connection (231, 234) and the cooling system component (130).

Example 10: The interface member (200) of Example 8 or Example 9, wherein the plurality of coolant connections (231, 234) are configured to form a part of a male-female fluid connection and/or a quick fluid connection.

Example 11: The interface member (200) of any of Example 8-Example 10, wherein each integrated coolant channel (221) is connected to a first and second coolant connection (231, 234) configured to be releasably connected to a cooling system component (130).

Example 12: The interface member (200) of Example 11, wherein the body portion (220) is provided with a plurality of integrated coolant channels (221) each being connected to a first and second coolant connection (231, 234) configured to be releasably connected to a cooling system component (130) such that a plurality of cooling system components (130) are selectively connectable to the coolant connection interface (230).

Example 13: The interface member (200) of any of Example 8-Example 12, wherein the body portion (220) is provided with at least one pump inlet (1394) connected to at least one coolant connection (231, 234) and configured to form an inlet of a pump (1301) to be mounted to the component mounting interface (240).

Example 14: The interface member (200) of Example 13, wherein the body portion (220) is provided with at least one pump outlet (1395) connected to the at least one coolant connection (231, 234) and configured to form an outlet of the pump (1301).

Example 15: The interface member (200) of any of Example 8-Example 14, wherein the component mounting interface (240) is configured to form a pump housing section (1391) configured to be connected to a mating housing section (1392) of the pump (1301) to together form the pump housing of said pump (1301).

Example 16: The interface member (200) of Example 15, wherein the component mounting interface (240) comprises a pump housing mounting (1393) for mounting of the mating housing section (1392).

Example 17: The interface member (200) of any of Example 1-Example 16, wherein the component mounting interface (240) is configured to accommodate mounting of one or more electrical components (1302, 1303) associated with the powertrain system (105) connected to a power source (103) of the powertrain system (100) by means of electrical circuitry (290).

Example 18: The interface member (200) of any of Example 1-Example 17, wherein the body portion (220) is provided with one or more electrical ground connections (291).

Example 19: The interface member (200) of Example 1, wherein the coolant connection interface (230) is configured to be releasably connected to two or more cooling system components (130) of the cooling system (105) such that coolant is distributed between the one or more cooling system components (130) via at least one of the one or more integrated coolant channels (221), wherein a first cooling system component (130) of the two or more cooling system components (130) is a pump (1301) and a second cooling system component of the two or more cooling system components (130) is a heat exchanger and wherein the component mounting interface (240) is configured to form a pump housing section (1391) configured to be connected to a mating housing section (1392) of the pump (1301) to together form the pump housing of said pump (301).

Example 20: A powertrain system (100) comprising at least one thermally managed component (102) and a cooling system (105), the cooling system (105) comprising an interface member (200) of any of Example 1-Example 19.

Example 21: The powertrain system (100) of Example 20, wherein the at least one thermally managed component (102) comprises one or more of an electrical motor, an energy storage system, a transmission system, a power takeoff unit (PTO), a control unit, a compressor, a power converter unit (1303), an on-board charger unit and/or an electrical power supply (1302).

Example 22: The powertrain system (100) of Example 20 or Example 21, wherein the support mounting interface (210) is configured to be mounted to a chassis.

Example 23: The powertrain system (100) of any of Example 20-Example 22, wherein the cooling system (105) is a liquid cooling system.

Example 24: A vehicle comprising a powertrain system of any of Example 20-Example 23.

Example 25: A marine vessel comprising a powertrain system of any of Example 20-23.

Example 26: A stationary drive system comprising a powertrain system of any of Example 20-23.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. Interface member for a cooling system for cooling at least one thermally managed component intended to form a part of a powertrain system, the interface member comprising:
a support mounting interface configured to be mounted to a support structure for supporting the interface member,
a body portion provided with one or more internal integrated coolant channels for forming at least a portion of a cooling circuitry of the cooling system,
a coolant connection interface in fluid communication with the one or more integrated coolant channel and configured to be releasably connected to one or more cooling system components of the cooling system connected to the cooling circuitry for coolant distribution between the one or more cooling system components and the cooling circuitry, and
a component mounting interface for mounting of one or more component associated with the powertrain system.

2. The interface member of claim 1, wherein the coolant connection interface is configured to be releasably connected to two or more cooling system components of the cooling system such that coolant is distributed between the one or more cooling system components via at least one of the one or more integrated coolant channels.

3. The interface member of claim 1, wherein the component mounting interface is configured to support at least one of the one or more cooling system components.

4. The interface member of claim 1, wherein the component mounting interface is configured to support at least one thermally managed component configured to be cooled by means of the cooling system.

5. The interface member of claim 1, wherein the one or more component associated with the powertrain system comprises a control unit, a pump, a compressor, a power converter unit, an on board charger unit and/or an electrical power supply and/or a heat exchanger.

6. The interface member of claim 1, further comprising sensor circuitry mounted to the body portion and configured to monitor the operation of the cooling system.

7. The interface member of claim 1, wherein the coolant connection interface comprises a plurality of coolant connections configured to be releasably connected to the one or more cooling system components of the cooling system.

8. The interface member of claim 1, wherein the coolant connections comprise sealing arrangements configured to provide a sealed connection between said coolant connection and the cooling system component.

9. The interface member of claim 7, wherein each integrated coolant channel is connected to a first and second coolant connection configured to be releasably connected to a cooling system component.

10. The interface member of claim 9, wherein the body portion is provided with a plurality of integrated coolant channels each being connected to a first and second coolant connection configured to be releasably connected to a cooling system component such that a plurality of cooling system components are selectively connectable to the coolant connection interface.

11. The interface member of claim 7, wherein the body portion is provided with at least one pump inlet connected to at least one coolant connection and configured to form an inlet of a pump to be mounted to the component mounting interface.

12. The interface member of claim 11, wherein the body portion is provided with at least one pump outlet connected to the at least one coolant connection and configured to form an outlet of the pump.

13. The interface member of claim 7, wherein the component mounting interface is configured to form a pump housing section configured to be connected to a mating housing section of the pump to together form the pump housing of said pump.

14. The interface member of claim 1, wherein the component mounting interface is configured to accommodate mounting of one or more electrical components associated with the powertrain system connected to a power source of the powertrain system by means of electrical circuitry.

15. The interface member of claim 1, wherein the body portion is provided with one or more electrical ground connection.

16. The interface member of claim 1, wherein the coolant connection interface is configured to be releasably connected to two or more cooling system components of the cooling system such that coolant is distributed between the one or more cooling system components via at least one of the one or more integrated coolant channels, wherein a first cooling system component of the two or more cooling system components is a pump and a second cooling system component of the two or more cooling system components is a heat exchanger and wherein the component mounting interface is configured to form a pump housing section configured to be connected to a mating housing section of the pump to together form the pump housing of said pump.

17. A powertrain system comprising at least one thermally managed component a cooling system, the cooling system comprising an interface member of claim 1.

18. The powertrain system of claim 17, wherein the at least one thermally managed component comprises one or more of an electrical motor, an energy storage system, a transmission system, a power takeoff unit, a control unit, a compressor, a power converter unit, an on-board charger unit and/or an electrical power supply.

19. The powertrain system of claim 17, wherein the support mounting interface is configured to be mounted to a chassis.

20. The powertrain system of claim 17, wherein the cooling system is a liquid cooling system.
